(19) United States
(12) Patent Application Publication
(10) Pub. No.: US 2023/0106483 A1
(43) Pub. Date: Apr. 6, 2023

(54) SEO PIPELINE INFRASTRUCTURE FOR SINGLE PAGE APPLICATIONS WITH DYNAMIC CONTENT AND MACHINE LEARNING

(71) Applicant: ADOBE INC., SAN JOSE, CA (US)

(72) Inventors: Richard Pong Nam Sinn, Milpitas, CA (US); Thomas Todd Donahue, Carlsbad, CA (US); Allan Morgan Young, Santa Rosa, CA (US); Nguyen Khanh Do, San Jose, CA (US)

(21) Appl. No.: 17/495,001

(22) Filed: Oct. 6, 2021

(51) Int. Cl. G06F 16/958; G06F 16/951; G06N 20/00

(52) U.S. Cl. CPC G06F 16/972; G06F 16/951; G06N 20/00

(57) ABSTRACT

Systems and methods for content management are described. One or more embodiments of the present disclosure receive a user request for a content page, wherein the content page includes a content item from a content source, determine that the user request is from a non-automated user, provide a user version of the content page to the non-automated user based on the determination that the user request is from the non-automated user, wherein the user version of the content page includes metadata linking to a related content item from a source other than the content source, receive an automated request for the content page, determine that the automated request is from an automated system, and provide an alternate version of the content page to the automated system based on the determination that the user request is from the automated system, wherein the alternate version of the content page includes additional metadata linking to a plurality of additional content items.

### BACKGROUND

The following relates generally to content management, and more specifically to content management using machine learning.

Content management systems use computers to collect, retrieve, deliver, and transmit information of any form. Content management techniques can be used for search, refinement, and recommendation of content. For example, a computer may be programmed to perform content search on a database and retrieve relevant results based on user preferences. Content management software can include customizable rules for searching in a database and rules for filtering the search results, where the filtered results are transmitted to users. In some cases, search engine optimization (SEO) is performed to ensure that a particular content page ranks higher in query results so that more visitors are expected to click on the content page.

However, dynamic content from diverse sources cannot be integrated into some single page applications (SPAs) due to existing SEO equity algorithms, layout differences, etc. Therefore, there is a need in the art for an improved content management system that provides an SPA that can integrate content from multiple source websites in a manner that can be easily crawled by a search engine.

### SUMMARY

The present disclosure describes systems and methods for content management. Some embodiments of the present disclosure include a content management apparatus that perform search engine optimization (SEO) enabled integration. The content management apparatus provides a single page application (SPA) that tracks and retrieves dynamic content items from multiple source websites. SPA can be easily crawled by search engines. Additionally, the content management apparatus can determine whether a user request is from a human user or a bot such that a user version or an alternate version of the content page is retrieved based on the determination, respectively. The content management apparatus identifies a content label for a content item using unsupervised learning. In some examples, the unsupervised learning includes a latent Dirichlet allocation (LDA) clustering algorithm.

A method, apparatus, and non-transitory computer readable medium for content management are described. One or more embodiments of the method, apparatus, and non-transitory computer readable medium include receiving a user request for a content page, wherein the content page includes a content item from a content source; determining that the user request is from a non-automated user; providing a user version of the content page to the non-automated user based on the determination that the user request is from the non-automated user, wherein the user version of the content page includes metadata linking to a related content item from a source other than the content source; receiving an automated request for the content page; determining that the automated request is from an automated system; and providing an alternate version of the content page to the automated system based on the determination that the user request is from the automated system, wherein the alternate version of the content page includes additional metadata linking to a plurality of additional content items.

A method, apparatus, and non-transitory computer readable medium for content management are described. One or more embodiments of the method, apparatus, and non-transitory computer readable medium include identifying a content label for a content item using an unsupervised learning model; generating metadata corresponding to the content item based on the content label; receiving an automated request for a content page containing the content item; determining that the automated request is from an automated system; retrieving an alternate version of the content page based on the determination, wherein the content page comprises metadata linking the content item to a related content item having the content label; and providing the alternate version of the content page to the automated system in response to the automated request.

An apparatus and method for content management are described. One or more embodiments of the apparatus and method include a request manager configured to receive a request for a content page, and to determine whether the request is from an automated system; a content retrieval component configured to retrieve a user version of the content page if the request is from a non-automated user and to retrieve an alternate version of the content page if the request is from the automated system, wherein the user version and the alternative version include metadata linking to additional content items that have a same content label as a content item in the content page; and a page service component configured to provide the user version or the alternate version of the content page in response to the request.

### BRIEF DESCRIPTION OF THE DRAWINGS

FIG. 1 shows an example of a content management system according to aspects of the present disclosure.

FIG. 2 shows an example of a process for content management according to aspects of the present disclosure.

FIG. 3 shows an example of multiple versions of a single page application according to aspects of the present disclosure.

FIG. 4 shows an example of a content management apparatus according to aspects of the present disclosure.

FIG. 5 shows an example of a content management diagram according to aspects of the present disclosure.

FIG. 6 shows an example of a process for content management according to aspects of the present disclosure.

FIG. 7 shows an example of a process for creating a webhook according to aspects of the present disclosure.

FIG. 8 shows an example of a process for turning a single page application to a crawlable website according to aspects of the present disclosure.

FIG. 9 shows an example of a dynamic rendering pipeline with a webhook according to aspects of the present disclosure.

FIG. 10 shows an example of a process for bot detection according to aspects of the present disclosure.

FIG. 11 shows an example of a network graph generated using a clustering method according to aspects of the present disclosure.

FIG. 12 shows an example of a process for content management based on an automated request according to aspects of the present disclosure.

FIG. 13 shows an example of a process for providing a user version of a content page to a non-automated user according to aspects of the present disclosure.

FIG. 14 shows an example of a process for content label identification according to aspects of the present disclosure.

### DETAILED DESCRIPTION

The present disclosure describes systems and methods for content management. Some embodiments of the present disclosure include a content management apparatus that perform search engine optimization (SEO) based integration. The content management apparatus provides a single page application (SPA) that tracks and retrieves dynamic content items from multiple source websites and provides metadata that is detectable by search engine crawlers (i.e., bots). The content management apparatus can determine whether a user request is from a human user or a bot such that a user version or an alternate version of the content page is retrieved based on the determination, respectively. In some examples, the content management apparatus identifies a content label for a content item using unsupervised learning.

Business entities often have various products or software systems that need to be integrated before displaying to users. In some examples, a single content page may serve as a starting point for users to browse content retrieved from various software applications. These software applications include content from multiple website sources. However, conventional content management systems copy content from a website or redirect content to a target website without providing adequate metadata to indicate the presence and source of the content to web crawlers. Furthermore, content integration via copying or redirecting is time-consuming and labor intensive. Additionally, layout of the target website may be different from source applications and therefore the target website loses crawlability when searched on a search engine (e.g., search ranking is decreased).

Embodiments of the present disclosure include a content management apparatus that enables integration of content from source websites to a single page application while maintaining SEO equity and page layout compatibility. The content management apparatus can determine whether a user request is from a non-automated user or from an automated system. Accordingly, the apparatus is able to provide a user version or an alternate version of a content page based on respective determination. In some examples, the content management apparatus identifies a content label for a content item using unsupervised learning. The unsupervised learning method includes a latent Dirichlet allocation (LDA) clustering algorithm, a latent semantic analysis (LSA) algorithm, a probabilistic latent semantic analysis (PLSA) algorithm, or an Lda2vec algorithm. As a result, users receive diverse content on a single page application that can range across multiple topics or different software applications.

By performing the unconventional step of providing a customized version of the content page with metadata based on a user classification (i.e., human user or bot), embodiments of the present disclosure efficiently integrate and display dynamic content from multiple content sources that can keep users actively engaged over a prolonged period of time without compromising availability in a search engine. In some examples, an SEO based system automatically integrates and transmits content onto a single page application (e.g., a target website). Content items from various sources are registered using webhook that tracks and updates creation or deletion requests. A dynamic rendering component enables the target website to be crawlable by a search engine (i.e., top ranking in search results).

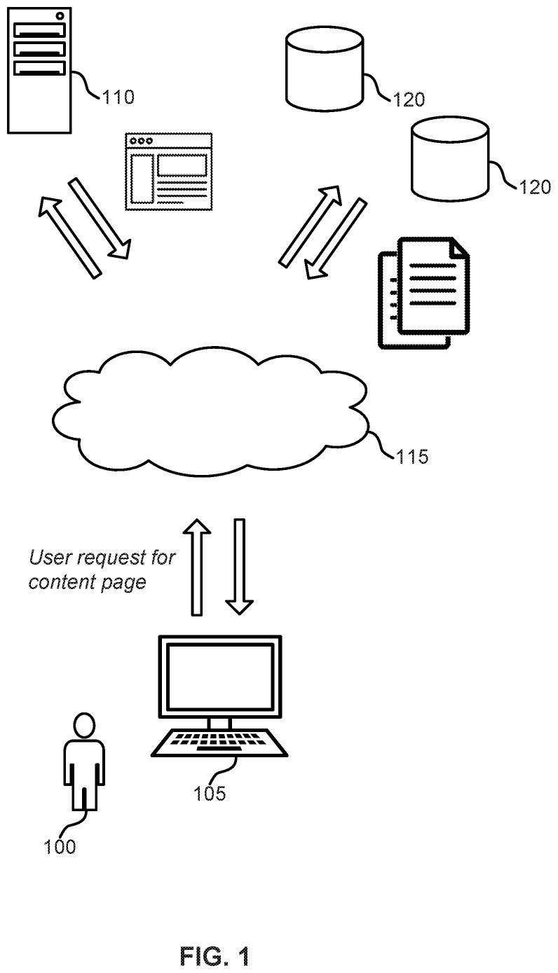

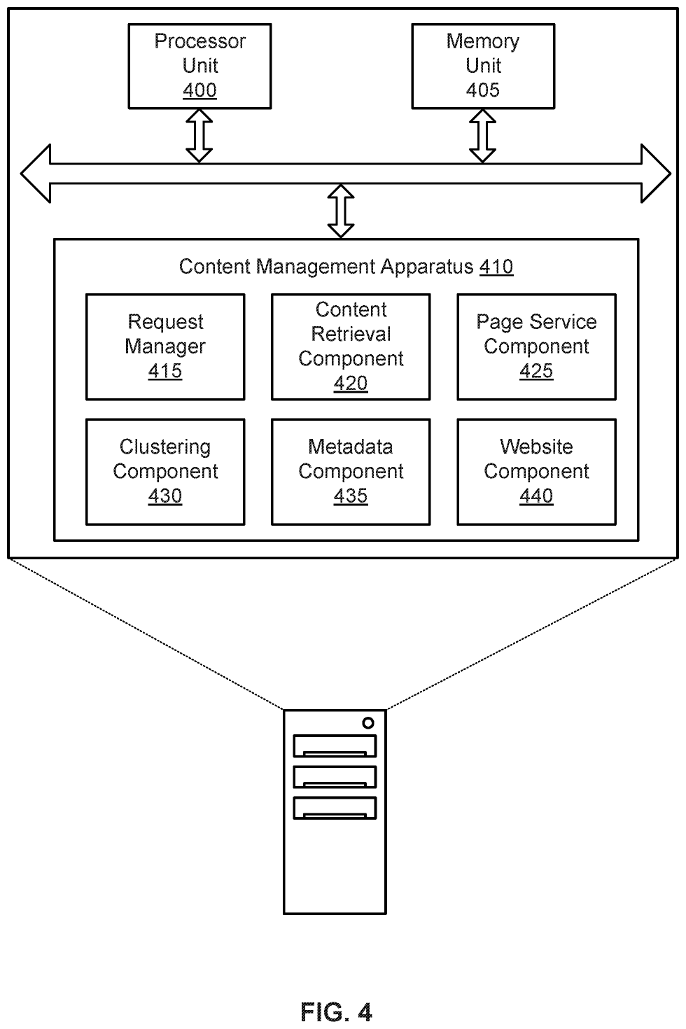

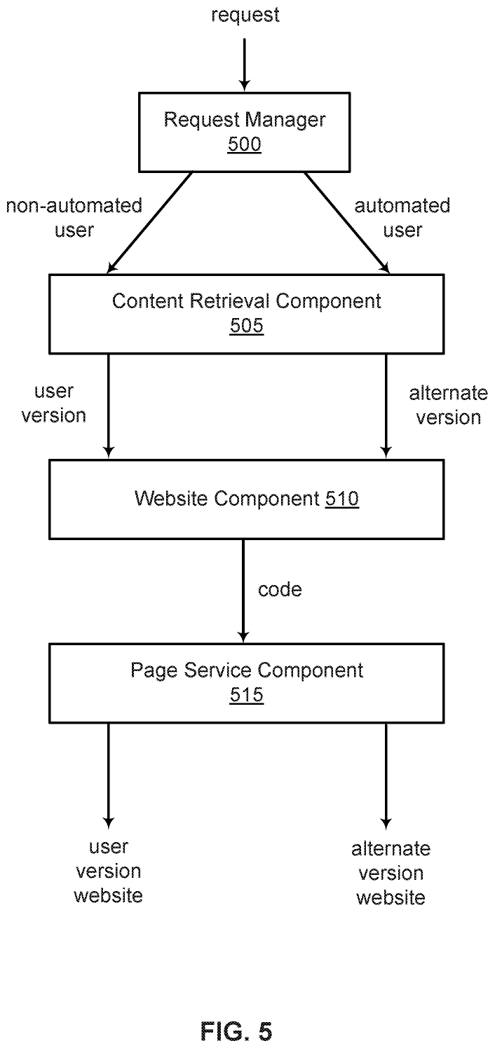

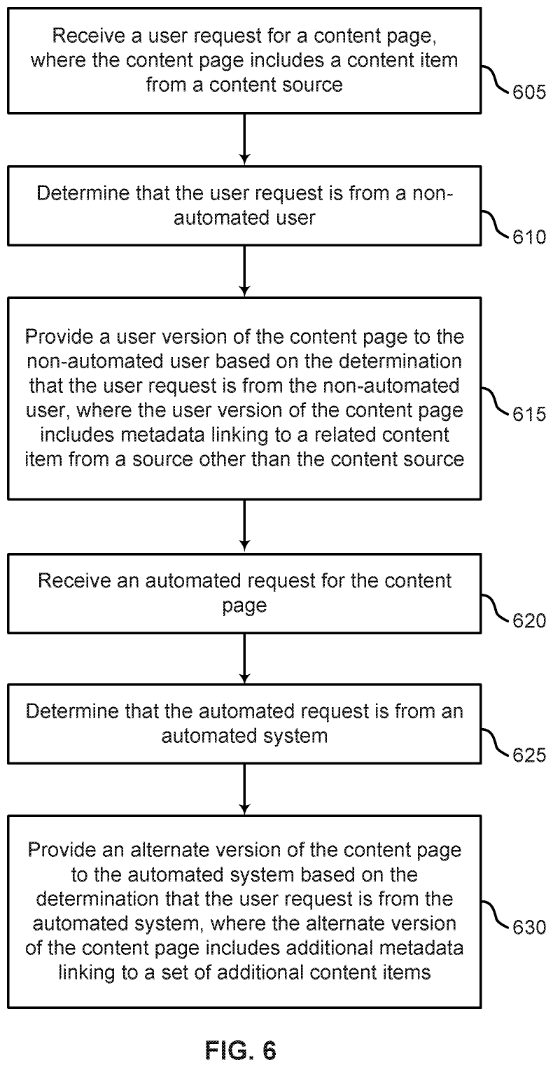

Embodiments of the present disclosure may be used in the context of a content management system (e.g., a software system that manages the presentation of content for a webpage). For example, a content management system based on the present disclosure may be used to retrieve relevant content items and provide a version of the single page application for users. An example application is provided with reference to FIGS. 1-3. Details regarding the architecture of an example content management apparatus are provided with reference to FIGS. 4-5. Examples of a process for content management are provided with reference to FIGS. 6-14.

### Content Management System

FIG. 1 shows an example of a content management system according to aspects of the present disclosure. The example shown includes user 100, user device 105, content management apparatus 110, cloud 115, and database 120. Content management apparatus 110 is an example of, or includes aspects of, the corresponding element described with reference to FIG. 4.

In the example of FIG. 1, user 100 may provide user request for a content page. For example, a software or application implemented on user device 105 receives website URL from user 100. Content management apparatus 110 receives a set of content items from database 120 associated with different source websites (e.g., represented by database 120 icons). The set of content items include articles relevant to one or more topics that are of interest to user 100. The user device 105 transmits the user request to the content management apparatus 110.

The user 100 communicates with the content management apparatus 110 via the user device 105 and the cloud 115. User 100 may be interested in receiving content items from multiple source websites on a single website page. For example, user 100 may be interested in receiving articles or tutorials demonstrating multiple different software applications. In some examples, the user device 105 communicates with the content management apparatus 110 via the cloud 115. In some embodiments, the content management apparatus 110 provides a user version of the content page to user 100.

Accordingly, content management apparatus 110 receives a user request for a content page, which includes a content item from a content source. Content management apparatus 110 determines that the user request is from a non-automated user (e.g., human users browsing webpages), and then provides a user version of the content page to the non-automated user based on the determination. The user version of the content page includes metadata linking to a related content item from a source other than the content source. In some examples, content management apparatus 110 receives an automated request for the content page and determines that the automated request is from an automated system. Content management apparatus 110 provides an alternate version of the content page to the automated system based on the determination. The alternate version of the content page includes additional metadata linking to a set of additional content items.

According to some embodiments, the user device 105 includes a user interface so that a user 100 can request for a content page via the user interface. A user interface may enable user 100 to interact with a device. In some embodiments, the user interface may include an audio device, such as an external speaker system, an external display device such as a display screen, or an input device (e.g., remote control device interfaced with the user interface directly or through an I0 controller module). In some cases, a user interface may be a graphical user interface (GUI) such as a web browser.

The user device 105 may be a personal computer, laptop computer, mainframe computer, palmtop computer, personal assistant, mobile device, or any other suitable processing apparatus. In some examples, the user device 105 includes software that incorporates a content management application. The content management application may either include or communicate with the content management apparatus 110. In some cases, content management apparatus 110 may be implemented on the user device 105.

Content management apparatus 110 includes a computer implemented system comprising a request manager, a content retrieval component, a page service component, a clustering component, a metadata component, and a website component. The system receives a user request for a content page, where the content page includes a content item from a content source. The system determines that the user request is from a non-automated user. The system provides a user version of the content page to the non-automated user based on the determination that the user request is from the non-automated user, where the user version of the content page includes metadata linking to a related content item from a source other than the content source. The system receives an automated request for the content page and determines that the automated request is from an automated system. The system provides an alternate version of the content page to the automated system based on the determination that the user request is from the automated system, where the alternate version of the content page includes additional metadata linking to a set of additional content items.

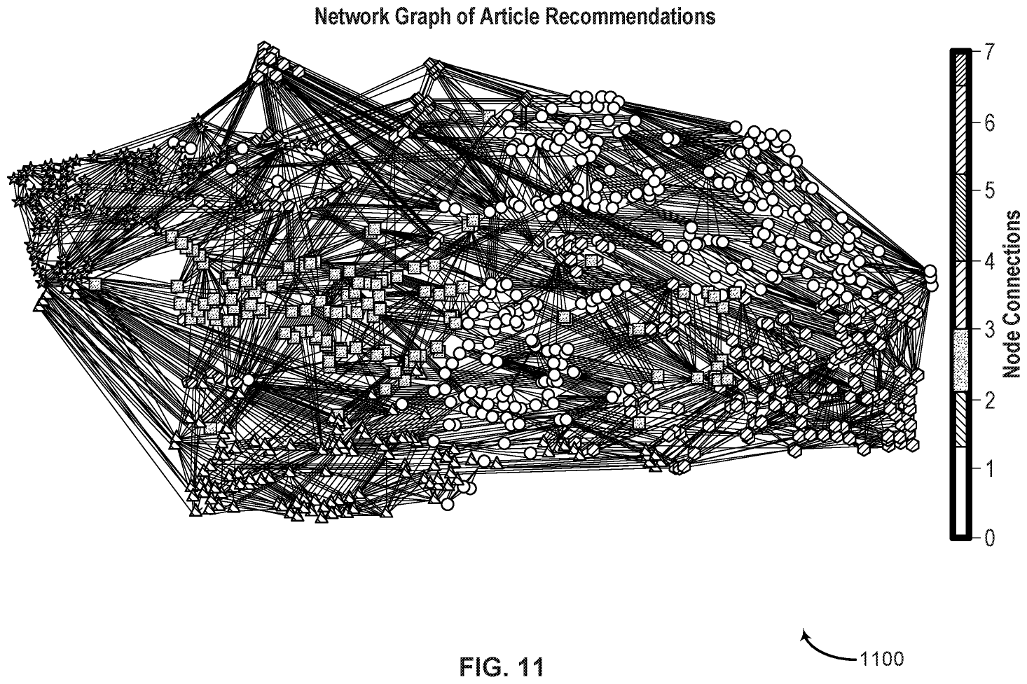

Content management apparatus 110 may also include a processor unit and a memory unit. Additionally, content management apparatus 110 can communicate with the one or more databases 120 via the cloud 115. Further detail regarding the architecture of content management apparatus 110 is provided with reference to FIGS. 4-5. Further detail regarding a process for content management is provided with reference to FIGS. 6-10. Further detail regarding content management using an unsupervised model is provided with reference to FIGS. 11-14.

In some cases, content management apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

A cloud 115 is a computer network configured to provide on-demand availability of computer system resources, such as data storage and computing power. In some examples, the cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud 115 is limited to a single organization. In other examples, the cloud 115 is available to many organizations. In one example, a cloud 115 includes a multi-layer communications network comprising multiple edge routers and core routers. In another example, a cloud 115 is based on a local collection of switches in a single physical location.

A database 120 is an organized collection of data. For example, a database 120 stores data in a specified format known as a schema. A database 120 may be structured as a single database, a distributed database, multiple distributed databases, or an emergency backup database. In some cases, a database controller may manage data storage and processing in a database 120. In some cases, a user interacts with database controller. In other cases, database controller may operate automatically without user interaction.

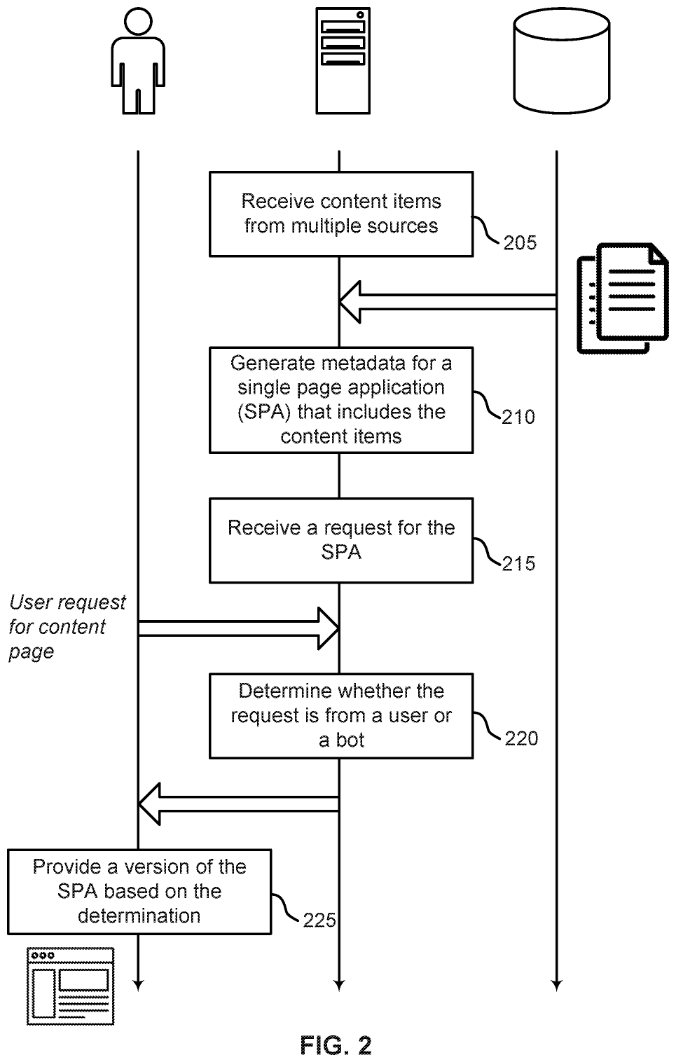

FIG. 2 shows an example of a process for content management according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system receives content items from multiple sources. In some cases, the operations of this step refer to, or may be performed by, a content management apparatus as described with reference to FIGS. 1 and 4. As already illustrated in FIG. 1, content may come from multiple different source websites (e.g., source websites are represented by database icon). The content items may have a different format or layout than a target website (e.g., a single page application).

At operation 210, the system generates metadata for an SPA that includes the content items. In some cases, the operations of this step refer to, or may be performed by, a content management apparatus as described with reference to FIGS. 1 and 4. For example, SPA tracks and retrieves dynamic content items from multiple source websites and is easily crawlable by search engines.

At operation 215, the system receives a request for the SPA. In some cases, the operations of this step refer to, or may be performed by, a content management apparatus as described with reference to FIGS. 1 and 4. In some examples, the system receives a request from a human user or receives a request from an automated system. The automated system may be a bot or an automated search engine.

At operation 220, the system determines whether the request is from a user or a bot. In some cases, the operations of this step refer to, or may be performed by, a content management apparatus as described with reference to FIGS. 1 and 4.

At operation 225, the system provides a version of the SPA based on the determination to a non-automated user or an automated system. In some cases, the operations of this step refer to, or may be performed by, a user as described with reference to FIG. 1. The system is an automated pipeline that moves content into SPA, accounts for SEO equity, and optimizes content search by search engines.

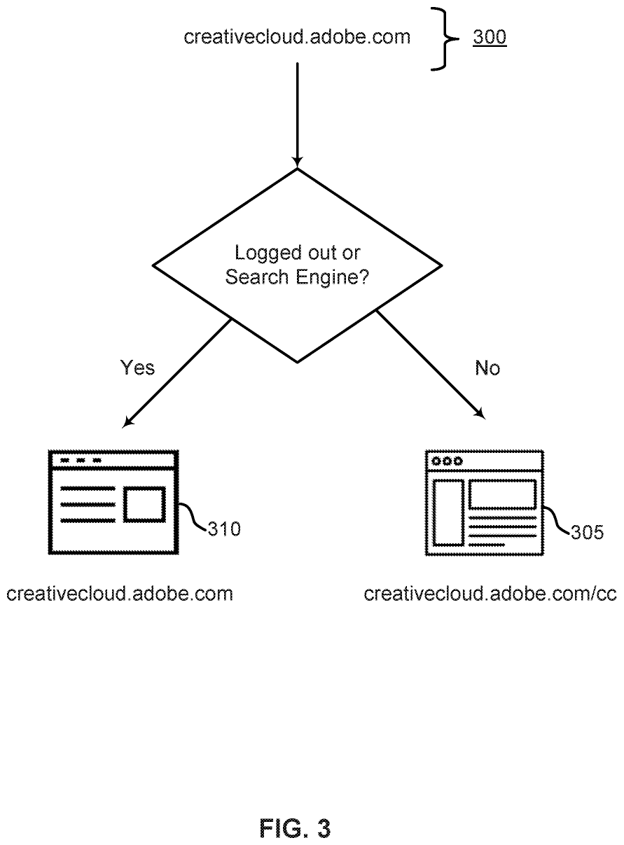

FIG. 3 shows an example of multiple versions of a single page application according to aspects of the present disclosure. The example shown includes user request 300, user version 305, and alternate version 310. In some cases, the content management system identifies a client, i.e., whether an automated system (i.e., a bot) or a non-automated user using a content delivery network (e.g., Adobe® CloudFront). As a result, the non-automated user is redirected to the normal browser while the bot is redirected into a bucket generated from pre-processing.

In some cases, integrating articles from multiple applications to the common repository might not be achieved due to deployment dependency on vendors and lack of suitability for the workflow of content management systems. Additionally, the articles to be integrated come from multiple website sources which results in different layouts of the articles. For example, the user interface is different for the layouts, i.e., when a user is logged in or logged out. In some cases, search engine crawlers may be prevented by single page applications. Therefore, a separate deployment process and a shareable container for both logged in and logged out clients is used.

In some examples, if a content management apparatus determines that the user request 300 is from a non-automated user, then a user version 305 of the content page is provided to the non-automated user. However, if the content management apparatus determines that the user request 300 is from an automated system (e.g., a search engine, bot), then an alternate version 310 of the content page is provided to the automated system.

The content management system can migrate multiple articles from a software application to the common repository of an SPA for logged in and logged out users. Prior to the migration of content, a software application may have accumulated SEO equity for the site.

In some embodiments, a SEO pipeline system can produce search engine crawlable pages from a single page application. The crawlable pages use dynamic content from a content management system (e.g., Adobe® Experience Manager) to preserve and increase website ranking. The content management system involves dynamic rendering, sitemaps, and recognition of content inside iframes by search engines, which will be described in greater detail below.

### System Architecture

In FIGS. 4-5, an apparatus and method for content management are described. One or more embodiments of the apparatus and method include a request manager configured to receive a request for a content page, and to determine whether the request is from an automated system; a content retrieval component configured to retrieve a user version of the content page if the request is from a non-automated user and to retrieve an alternate version of the content page if the request is from the automated system, wherein the user version and the alternative version include metadata linking to additional content items that have a same content label as a content item in the content page; and a page service component configured to provide the user version or the alternate version of the content page in response to the request.

Some examples of the apparatus and method further include a clustering component configured to identify a content label for the content item using an unsupervised learning model. Some examples of the apparatus and method further include a metadata component configured to generate the metadata based on a metadata schema for the content page.

Some examples of the apparatus and method further include a website component configured to generate code for the user version of the content page and to generate code for the alternate version of the content page.

FIG. 4 shows an example of a content management apparatus according to aspects of the present disclosure. The example shown includes processor unit 400, memory unit 405, and content management apparatus 410. Content management apparatus 410 includes request manager 415, content retrieval component 420, page service component 425, clustering component 430, metadata component 435, and website component 440. Content management apparatus 410 is an example of, or includes aspects of, the corresponding element described with reference to FIG. 1.

A processor unit 400 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 400 is configured to operate a memory array using a memory controller. In other cases, a memory controller is integrated into the processor. In some cases, the processor unit 400 is configured to execute computer-readable instructions stored in a memory to perform various functions. In some embodiments, a processor unit 400 includes special purpose components for modem processing, baseband processing, digital signal processing, or transmission processing.

Examples of a memory unit 405 include random access memory (RAM), read-only memory (ROM), or a hard disk. Examples of memory unit 405 include solid state memory and a hard disk drive. In some examples, a memory unit 405 is used to store computer-readable, computer-executable software including instructions that, when executed, cause a processor to perform various functions described herein. In some cases, the memory unit 405 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory unit 405 store information in the form of a logical state.

According to some embodiments, request manager 415 receives a user request for a content page, where the content page includes a content item from a content source. In some examples, request manager 415 determines that the user request is from a non-automated user. Request manager 415 receives an automated request for the content page. Request manager 415 determines that the automated request is from an automated system. In some examples, request manager 415 reads an identification field in the automated request that identifies a requesting entity as the automated system, where determining that the user request is from the non-automated user is based on the identification field.

According to some embodiments, request manager 415 receives an automated request for a content page containing the content item. In some examples, request manager 415 determines that the automated request is from an automated system. In some examples, request manager 415 receives a user request for the content page. Request manager 415 determines that a user requesting entity is from a non-automated user. According to some embodiments, request manager 415 is configured to receive a request for a content page, and to determine whether the request is from an automated system. Request manager 415 is an example of, or includes aspects of, the corresponding element described with reference to FIG. 5.

According to some embodiments, content retrieval component 420 provides a user version of the content page to the non-automated user based on the determination that the user request is from the non-automated user, where the user version of the content page includes metadata linking to a related content item from a source other than the content source. In some examples, content retrieval component 420 provides an alternate version of the content page to the automated system based on the determination that the user request is from the automated system, where the alternate version of the content page includes additional metadata linking to a set of additional content items. In some cases, content retrieval component 420 is configured to retrieve the user version of the content page and to retrieve the alternate version of the content page. Page service component 425 is configured to provide the user version or the alternate version of the content page in response to the request.

According to some embodiments, content retrieval component 420 retrieves an alternate version of the content page based on the determination, where the content page includes metadata linking the content item to a related content item having the content label.

According to some embodiments, content retrieval component 420 is configured to retrieve a user version of the content page if the request is from a non-automated user and to retrieve an alternate version of the content page if the request is from the automated system, wherein the user version and the alternative version include metadata linking to additional content items that have a same content label as a content item in the content page. Content retrieval component 420 is an example of, or includes aspects of, the corresponding element described with reference to FIG. 5.

According to some embodiments, page service component 425 provides the alternate version of the content page to the automated system in response to the automated request. In some examples, page service component 425 provides a user version of the content page to the non-automated user in response to the user request.

According to some embodiments, page service component 425 is configured to provide the user version or the alternate version of the content page in response to the request. Page service component 425 is an example of, or includes aspects of, the corresponding element described with reference to FIG. 5.

According to some embodiments, clustering component 430 identifies one or more content labels for the content item using an unsupervised learning model. In some examples, clustering component 430 generates a vector representation for the content item using the unsupervised learning model based on key words in the content item. Clustering component 430 generates an additional vector representation for each of a set of additional content items using the unsupervised learning model. Clustering component 430 computes a distance between the vector representation and each of the additional vector representations. Clustering component 430 then identifies the content label for the content item and each of the additional content items based on the distance.

In some embodiments, the unsupervised learning model includes a latent Dirichlet allocation (LDA) clustering algorithm, a latent semantic analysis (LSA) algorithm, a probabilistic latent semantic analysis (PLSA) algorithm, or an Lda2vec algorithm. In some examples, clustering component 430 identifies a pre-determined set of topics, where the unsupervised learning model clusters content based on the pre-determined set of topics.

According to some embodiments, metadata component 435 generates the metadata corresponding to the content item based on the one or more content labels. In some examples, the additional metadata is not contained in the user version of the content page. In some examples, metadata component 435 identifies source metadata for the content item. Next, metadata component 435 converts the source metadata based on a metadata schema for a website to obtain the metadata.

According to some embodiments, the additional metadata includes a web link to each of the set of additional content items. In some examples, the metadata includes a keyword identifying a content label associated with the content item and the related content item. According to some embodiments, metadata component 435 is configured to generate the metadata based on a metadata schema for the content page.

According to some embodiments, the automated system includes a web crawler for a search engine. In some examples, website component 440 generates a webhook for the content source. Next, website component 440 receives the content item from the content source based on the webhook. In some examples, website component 440 receives an update to the content item based on the webhook. Website component 440 then updates code for the user version of the content page based on the update.

According to some embodiments, website component 440 is configured to generate code for the user version of the content page and to generate code for the alternate version of the content page. Website component 440 is an example of, or includes aspects of, the corresponding element described with reference to FIG. 5.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

FIG. 5 shows an example of a content management diagram according to aspects of the present disclosure. The example shown includes request manager 500, content retrieval component 505, website component 510, and page service component 515.

As an example illustrated in FIG. 5, request manager 500 receives a request for a content page. The request may be from a non-automated user or an automated system. Request manager 500 is an example of, or includes aspects of, the corresponding element described with reference to FIG. 4. The request manager 500 determines that the request is from a non-automated user or an automated user.

According to an embodiment, content retrieval component 505 is configured to retrieve a user version of the content page if the request is from a non-automated user and to retrieve an alternate version of the content page if the request is from the automated system, where the user version and the alternative version include metadata linking to additional content items that have a same content label as a content item in the content page. Content retrieval component 505 is an example of, or includes aspects of, the corresponding element described with reference to FIG. 4.

According to an embodiment, website component 510 is configured to generate code for the user version of the content page and to generate code for the alternate version of the content page. The content management apparatus (see FIG. 4) receives an update to the content item based on the webhook. The code can be updated for the user version of the content page based on the update. Website component 510 is an example of, or includes aspects of, the corresponding element described with reference to FIG. 4.

According to an embodiment, page service component 515 is configured to provide the user version or the alternate version of the content page in response to the request. In some examples, a non-automated user (i.e., human user) receives a user version of a website. An automated system (i.e., bot) receives an alternate version of the website. Page service component 515 is an example of, or includes aspects of, the corresponding element described with reference to FIG. 4.

### Content Management

In FIGS. 6-10, a method, apparatus, and non-transitory computer readable medium for content management are described. One or more embodiments of the method, apparatus, and non-transitory computer readable medium include receiving a user request for a content page, wherein the content page includes a content item from a content source; determining that the user request is from a non-automated user; providing a user version of the content page to the non-automated user based on the determination that the user request is from the non-automated user, wherein the user version of the content page includes metadata linking to a related content item from a source other than the content source; receiving an automated request for the content page; determining that the automated request is from an automated system; and providing an alternate version of the content page to the automated system based on the determination that the user request is from the automated system, wherein the alternate version of the content page includes additional metadata linking to a plurality of additional content items.

Some examples of the method, apparatus, and non-transitory computer readable medium further include reading an identification field in the automated request that identifies a requesting entity as the automated system, wherein determining that the user request is from the non-automated user is based on the identification field. Some examples of the method, apparatus, and non-transitory computer readable medium further include identifying one or more content labels for the content item using an unsupervised learning model. Some examples further include generating the metadata corresponding to the content item based on the one or more content labels. In some embodiments, the additional metadata is not contained in the user version of the content page. In some examples, the automated system comprises a web crawler for a search engine.

Some examples of the method, apparatus, and non-transitory computer readable medium further include generating a webhook for the content source. Some examples further include receiving the content item from the content source based on the webhook. Some examples of the method, apparatus, and non-transitory computer readable medium further include receiving an update to the content item based on the webhook. Some examples further include updating code for the user version of the content page based on the update. Some examples of the method, apparatus, and non-transitory computer readable medium further include storing the content item and the related content item in a common database.

Some examples of the method, apparatus, and non-transitory computer readable medium further include identifying source metadata for the content item. Some examples further include converting the source metadata based on a metadata schema for a website to obtain the metadata. According to some embodiments, the additional metadata comprises a web link to each of the plurality of additional content items. In some examples, the metadata comprises a keyword identifying a content label associated with the content item and the related content item.

FIG. 6 shows an example of a process for content management according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system receives a user request for a content page, where the content page includes a content item from a content source. In some cases, the operations of this step refer to, or may be performed by, a request manager as described with reference to FIGS. 4 and 5.

In some cases, a software application, for example Adobe® Behance, uses certain format to store information in a content management system. Similarly, other software applications (e.g., Learn, Illustrator, etc.) use similar or different formats to store data in their respective systems. Additionally, a copy of content within a software application (e.g., Helpx) can be made available within the common repository.

The content management system includes a search engine optimization (SEO) pipeline infrastructure for automatically integrating content into the SPA. One or more embodiments of the present disclosure include an automated pipeline system which moves content into an SPA, accounts for SEO equity, and optimizes content search using a search engine. In some examples, the integration of content includes three steps (i.e., registration, main processing, and post-processing).

At operation 610, the system determines that the user request is from a non-automated user. In some cases, the operations of this step refer to, or may be performed by, a request manager as described with reference to FIGS. 4 and 5.

At operation 615, the system provides a user version of the content page to the non-automated user based on the determination that the user request is from the non-automated user, where the user version of the content page includes metadata linking to a related content item from a source other than the content source. In some cases, the operations of this step refer to, or may be performed by, a content retrieval component along with a page service component as described with reference to FIGS. 4 and 5.

At operation 620, the system receives an automated request for the content page. In some cases, the operations of this step refer to, or may be performed by, a request manager as described with reference to FIGS. 4 and 5.

At operation 625, the system determines that the automated request is from an automated system. In some cases, the operations of this step refer to, or may be performed by, a request manager as described with reference to FIGS. 4 and 5.

At operation 630, the system provides an alternate version of the content page to the automated system based on the determination that the user request is from the automated system, where the alternate version of the content page includes additional metadata linking to a set of additional content items. In some cases, the operations of this step refer to, or may be performed by, a content retrieval component along with a page service component as described with reference to FIGS. 4 and 5.

According to an embodiment of the present disclosure, the content management system includes a single starting application or platform (e.g., Adobe® CC Home) for search engines or non-automated users to browse through various content without authentication.

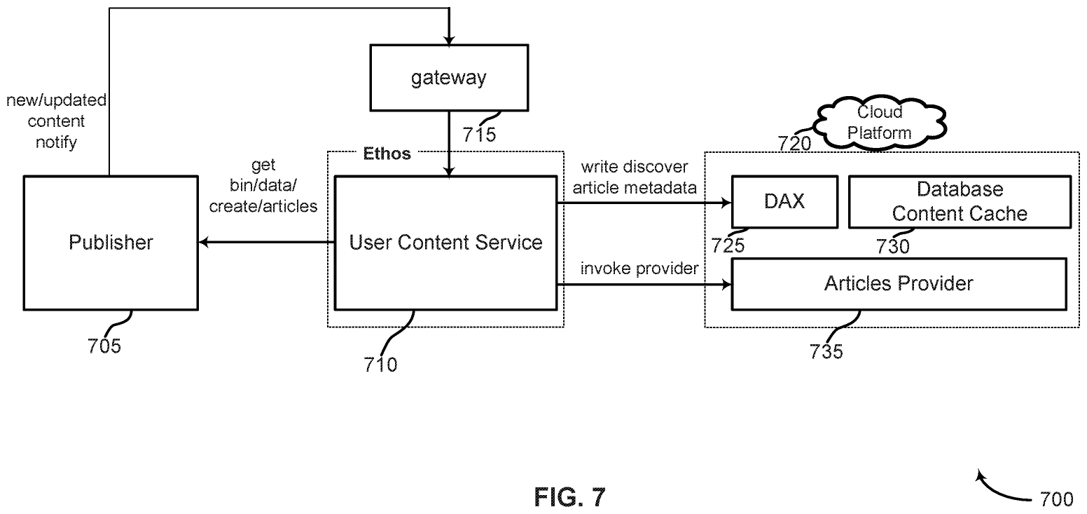

FIG. 7 shows an example of a process for creating a webhook according to aspects of the present disclosure. According to an embodiment of the present disclosure, the content management system 700 includes publisher 705 (e.g., a service for publishing a web page), a user content service 710, a gateway 715, and a cloud platform a cloud platform 720 that includes a data analysis expressions (DAX) component 725, a database content cache 730, and an articles provider 735. In one example, the publisher 705 publishes articles directly, e.g., based on a webhook established with the user content service 710.

In some cases, the webhook is called upon to register the content before publishing. For example, a webhook can register each create event, update event, or delete event. Notifications may be sent to the user content service 710 via the gateway 715. Content, such as articles, along with metadata about the articles can be stored in a cloud platform 720. For example, articles can be stored in an articles provider 735, and metadata can be stored in a databased content cache 730 according to a format generated by the DAX component 725.

According to an embodiment, the content management system 700 includes a registration component where an article triggers a call to a service webhook. The webhook validates the request and invokes processing function, i.e., articles provider 735. In some cases, articles provider 735 updates the article database while generating a languages sitemap and a sitemap index. Additionally, the articles provider 735 invokes the SEO rendering pipeline which performs pre-rendering of the article content.

According to an embodiment, webhook is hosted on user content service 710 (e.g., an ethos-based service). For example, a webhook is invoked when authored articles are created, updated, or deleted on a content service or an analytics service such as Adobe® Experience Manager (AEM). A request component includes articles to update and to delete. The content management system 700 validates incoming request based on security requirements and invokes articles provider 735. In some cases, a webhook may be provided with the user content service 710, which monitors and provides content from the cloud platform 720.

According to an embodiment, the content management system 700 receives article metadata from a webhook on the user content service 710 (e.g., data about updates and deletes to content). The content management system 700 validates metadata using a validation method such as JSON schema validation. Article metadata is then transformed to conform to homepage metadata schema requirements. The content management system 700 performs differencing to determine whether changes to the articles database are needed. The system updates articles database based on the determination (used by UCS for client article query support).

One or more embodiments of the present disclosure create sitemaps which include website addresses (i.e., URLs). In some cases, the language-based sitemaps and the overall sitemap index are uploaded to the bucket generated from pre-processing. Next, the articles provider 735 invokes an SEO rendering pipeline and provides the rendering article metadata to render and delete. Example of cloud platform include Amazon Web Services (AWS), Google Cloud Platform, or Microsoft Azure.

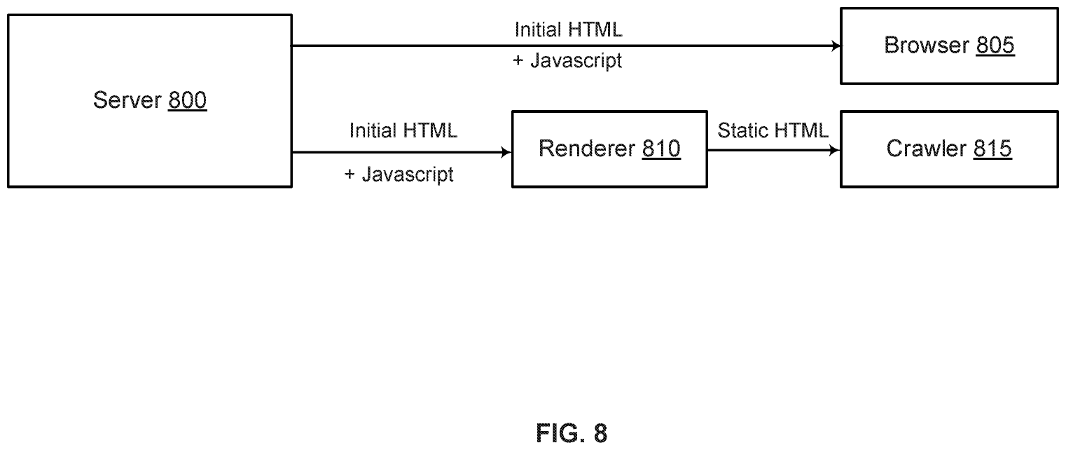

FIG. 8 shows an example of a process for turning a single page application to a crawlable website according to aspects of the present disclosure. The example shown includes server 800, browser 805, renderer 810 and crawler 815. FIG. 8 depicts an example of a process in which different versions of a webpage are transmitted to users (e.g., a user that is using browser 805) and an automated system such as a crawler 815 (e.g., a search engine crawler).

In some cases, a user wants to access a single page application. In this case, the server 800 determines that the user is a human user with a browser 815. Thus, the sever 800 provides the requesting browser 805 with code such as HTML and JavaScript that can be used to render a page.

Alternatively, the server 800 recognizes that an automated crawler 815 is requesting the page. Thus, the server 800 provides the code (e.g., HTML and JavaScript) to a renderer 810, so that a static HTML page can be provided to the crawler 815, which will enable the crawler 815 to obtain more complete metadata for the content in the single page application. Thus, the crawler 815 is redirected into a static HTML bucket obtained from pre-processing by the renderer 810. For example, a client that is an SEO search engine may see files that are different from those presented to a browser 805. A single page application is turned into a crawlable website.

According to some embodiments, the content management apparatus is configured to register content using webhook (i.e., registration process) as described above with reference to FIG. 7. Content that is copied to the common repository can be registered with webhook (e.g., CC Home webhook). The webhook is invoked when content or a publishable article is changed (e.g., the article is created, changed, or deleted). Next, the request body to the webhook includes having the content updated or deleted. Additionally, the webhook validates requests as per security requirements. By using the renderer 810 to generate static HTML from the content provided based on the webhook, dynamic metadata can be provided to the crawler 815 that improves search results.

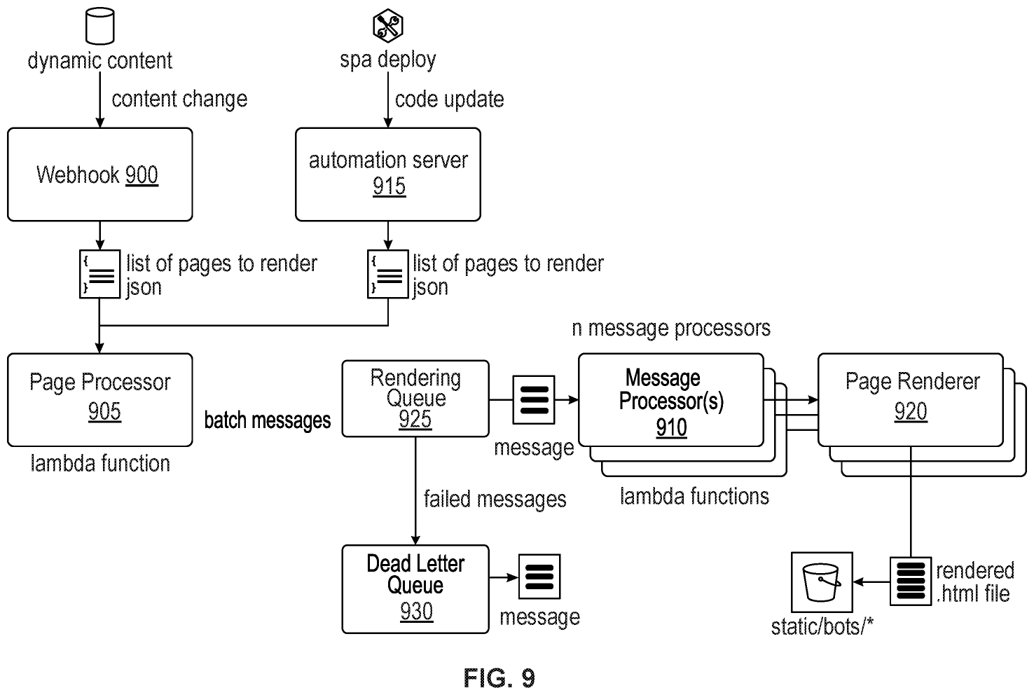

FIG. 9 shows an example of a dynamic rendering pipeline with a webhook according to aspects of the present disclosure. The example shown includes webhook 900, page processor 905, message processor 910, automation server 915, page renderer 920, SQS rendering queue 925, SQS dead letter queue 930. The dynamic rendering pipeline of FIG. 9 depicts an example of a how content can be rendered for an automated system as described with reference to FIG. 8. That is, in some cases, code (e.g., HTML and JavaScript) that is provided to a user using a browser is automatically rendered and served to automated systems (e.g., search engine crawlers) as static HTML (e.g., to improve search engine results).

According to an embodiment, when there is content change (e.g., from create), the webhook 900 is notified and generates a list of pages to render for the dynamic rendering pipeline. On the right, a build scheduling system (e.g., Jenkins) is then notified when there is code change in the SPA. These requests to generate a list of pages are then be funneled to the page processor 905. The page processor 905 can start multiple message processors 910 which in turn starts multiple page renderers 920. A page renderer 920 can use a page rendering engine to render a page. Multiple message processors 910 and multiple page renderers 920 can work together to enable multiple processing computing to allow fast processing of page rendering for the dynamic rendering pipeline.

According to an embodiment, a webhook 900 is configured to detect changes in the content of articles from multiple external sources. In some cases, the metadata of dynamic content of the incoming articles is also modified, followed by validation of the list of article pages to render using data interchange format such as JSON. Then, static page code provided for a single page application can be generated by updating the code using automation server 915. For example, the automation server 915 can use an open-source automation server such as Jenkins®. Thus, organizations can accelerate the software development process by automating parts of the process. The automation server 915 manages and controls software delivery processes throughout the entire lifecycle. After the code is updated, JSON validation is performed for the list of pages to render.

Page processing can be performed by serverless functions, such as lambda functions, after the validation which is followed by the pages being added to the rendering queue 925. In some cases, failed processed batch messages from the rendering queue 925 reach the dead letter queue 930. The rendering queue 925 includes or applies a message queuing service which helps send, store, and receive messages from different application components to another. In some examples, the rendering queue 925 and the dead letter queue 930 includes a queue service such as Amazon® simple queue service (SQS), which is a fully managed message queuing service that help decouple and scale microservices, distributed systems, and serverless applications. Alternatively, the messages from the rendering queue 925 may reach a message processor 910 lambda function and then the page renderer 920. The pre-rendered message or file from the page renderer 920 is then placed in a bucket and used by robots of the SEO (e.g., google bot or search bot). In some examples, page renderer 920 is deemed a puppeteer (e.g., using headless Chrome).

According to an embodiment, the content management system performs main processing after registration. The main processing uses serverless compute units and is performed in two parts (i.e., metadata-related and dynamic rendering pipeline). The content management system receives and validates metadata of incoming articles. In some examples, a JSON schema validation is performed to ensure the articles are correct.

Next, the system transforms the article metadata according to the SPA (e.g., according to the home page) schema requirements. In some cases, SPA is also referred to as a target website. Additionally, the system determines changes needed for article database followed by update of article database. In an embodiment, article database stores articles of a particular type from multiple web-based sources. The content management system keeps track of articles available in the database which provides an index for the search engine. A sitemap is generated for all languages which the search engine may pick.

The metadata related step is followed by the dynamic rendering pipeline where a multiple processor page renderer 920 is used to create search engine content based on input metadata. Accordingly, dynamic rendering turns an SPA into a crawlable website for detection by automated systems (bots). For example, in the content that is rendered, each of the pages belong to the article database. However, if the content belongs to an external source, page rendering ensures that the content is crawlable by the search engine.

According to an embodiment, registration with webhook is followed by the main processing pipeline step which is a serverless compute system that updates the database. The content management system includes a processing and page-rendering system for each article. In some cases, each page of the content is pre-rendered using a standard engine.

In one example, 1000 articles are obtained from external sources and a multi-processing assignment is performed for each article. Each article is rendered in a pre-render state. In some cases, a processing step is performed on the incoming content where the page is pre-rendered and put in a static page storage so that automated systems (e.g., a search bot) can reach the pre-rendered page. The pre-rendering and robot detection occurs in real-time, i.e., when a user is reading the web article.

Accordingly, in some embodiments, the content management system includes an SEO pipeline model that can process large amounts of pre-rendering at a high speed. In some cases, a user may see the SPA based on code rendered within a browser, while a crawler is redirected to static HTML obtained from the pre-processing described above with reference to FIG. 9.

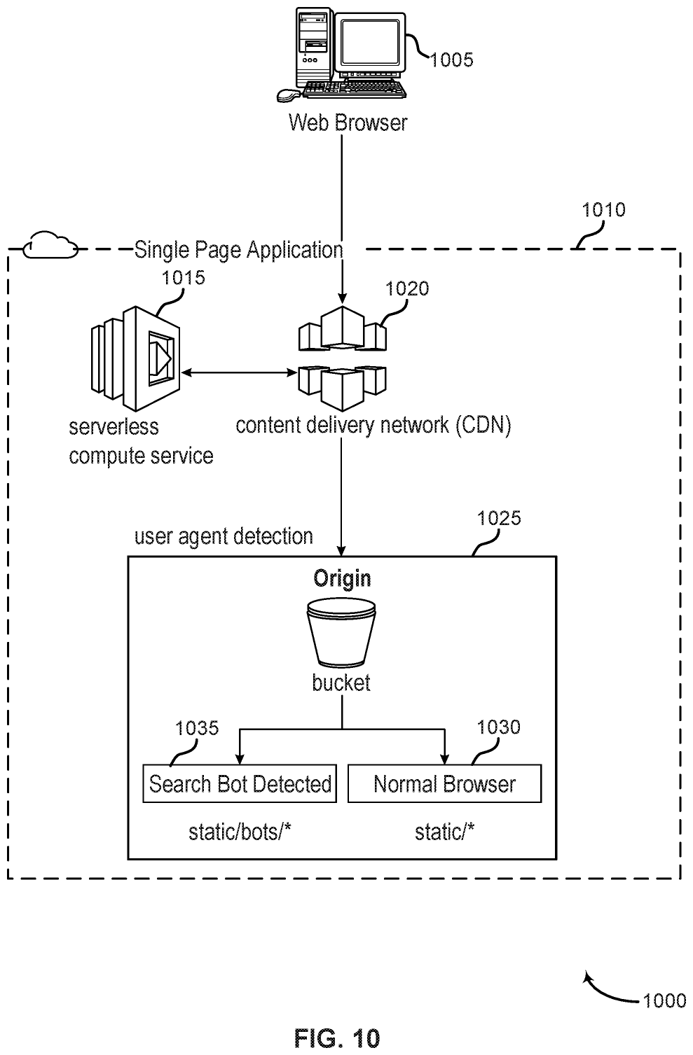

FIG. 10 shows an example of a process for bot detection according to aspects of the present disclosure. According to the example depicted in FIG. 10, a browser 1005 requests an SPA 1010 on the cloud. A CDN 1020 serves content with the support of a serverless compute service 1015 after performing a user agent detection 1025. For example, it is determined the content is requested by the browser 1005, content can be served from a first source 1030 that provides code (e.g., HTML and JavaScript) that can be rendered by the browser. Alternatively, if the user agent detection 1025 determines that the SPA 1010 is requested by an automated system such as a search engine bot, static content can be served from a second source 1035 that provides pre-rendered SPA that enables the automated system to retrieve metadata useful for enabling search results.

In one embodiment, a field of the page request indicates whether the type of entity making the request, and the determination about the type of entity is made based on such a field in the request. Additionally or alternatively, a configurable text-based rule is used to determine whether the user agent is associated with access from a human user or from an automated system such as a search engine bot. For example, a rule may indicate that a user agent matching a regular expression indicates a human user (e.g., the request may contain text indicating a commonly used browser, or may include words such as “index”, “scrape”, “crawl”, etc. that indicate an automated source). In some embodiments, the user agent detection system is configured to match multiple regular expressions and determine which regular expression has the highest match. In other embodiments, a point-based system may be employed such that, for each regular expression matched, a human versus bot score is generated and the final score is used to determine whether the access is judged to be a human user or an automated system.

In some examples, a content creation service (e.g., Adobe® CREATE) is one of the content sources used in a home web page (e.g., CC Home). The home web page is set up to use multiple content sources. Human editors may create content in a content creation authoring instance and the content is mirrored to two multiple dispatchers for the load balancer to access. The home web page uses this load balancer to access the content as a client. In some cases, bot and automated systems are used interchangeably.

A content delivery network (CDN) is a geographically distributed network of proxy servers and their data centers. Using a CDN can lead to increased availability and performance by distributing the service spatially relative to end users. A CDN enables quick transfer of assets needed for loading Internet content including HTML pages, JavaScript files, stylesheets, images, and videos. In some examples, popular CDNs include Amazon® CloudFront, Akamai, Cloudflare, Verizon Media, etc. Embodiments of the present disclosure are not limited to above-mentioned CDNs. In some examples, a CDN can communicate with serverless compute service/system (e.g., lambda edge).

A CDN may be configured in a manner that a user inputs a particular URL to access the home website. If the URL does not begin with /create/*, /content/*, /etc/*, or /etc.clientlibs/*, it will go to an SPA. If the URL starts with /create/*, the URL is redirected to the content in create via the load balancer. This can be used as an example of how a home web page supports multiple content sources. Embodiments of the present disclosure are not limited to “create” status. In some examples, content delivery network proceeds to determine whether a search bot is detected (static/bots*) or it is a normal browser (static/*). In some examples, the cloud platform is implemented using a cloud server such as Amazon Web Services (AWS), Google Cloud Platform, or Microsoft Azure.

### Content Management Using Unsupervised Learning

In FIGS. 11-14, a method, apparatus, and non-transitory computer readable medium for content management are described. One or more embodiments of the method, apparatus, and non-transitory computer readable medium include identifying a content label for a content item using an unsupervised learning model; generating metadata corresponding to the content item based on the content label; receiving an automated request for a content page containing the content item; determining that the automated request is from an automated system; retrieving an alternate version of the content page based on the determination, wherein the content page comprises metadata linking the content item to a related content item having the content label; and providing the alternate version of the content page to the automated system in response to the automated request.

Some examples of the method, apparatus, and non-transitory computer readable medium further include receiving a user request for the content page. Some examples further include determining that a user requesting entity is from a non-automated user. Some examples further include providing a user version of the content page to the non-automated user in response to the user request.

Some examples of the method, apparatus, and non-transitory computer readable medium further include generating a vector representation for the content item using the unsupervised learning model based on key words in the content item. Some examples further include generating an additional vector representation for each of a plurality of additional content items using the unsupervised learning model. Some examples further include computing a distance between the vector representation and each of the additional vector representations. Some examples further include identifying the content label for the content item and each of the additional content items based on the distance.

According to some embodiments, the unsupervised learning model comprises a latent Dirichlet allocation (LDA) clustering algorithm, a latent semantic analysis (LSA) algorithm, a probabilistic latent semantic analysis (PLSA) algorithm, or an Lda2vec algorithm.

Some examples of the method, apparatus, and non-transitory computer readable medium further include identifying a pre-determined set of topics, wherein the unsupervised learning model clusters content based on the pre-determined set of topics.

FIG. 11 shows an example of a network graph generated using clustering method according to aspects of the present disclosure. The example includes a network graph 1100. One or more embodiments of the present disclosure generate topics and computationally ensure that by accessing one of them, a client can be linked to articles in the complete SEO network. In some cases, an article is scored using unsupervised learning and one or more articles may be grouped into different topics. For example, an unsupervised learning model may include a latent Dirichlet allocation (LDA) model, KBTree, etc. When a client (e.g., a search engine bot) clicks on an article, a list of different topics that the client can crawl is provided which enables the client to access the entire site.

In some cases, a software application that includes pre-rendered articles may list or categorize articles by topic which increases level of user engagement, and enables the generation of metadata which can be used to improve search results. In some cases, when a user clicks on an article, a search engine ensures that the user can access content across the entire site based on the metadata (e.g., the links among the different content items).

According to some embodiments, the content management system can recommend new related articles to a user. For example, multiple article recommendations may be delivered to a user who reads a specific article (e.g., on Adobe® Creative Cloud (“CC”) Home Discover). A machine learning model is trained to select multiple article recommendations based on feedback from users.

According to an embodiment, the content management system includes an unsupervised learning model for topic modeling based on text of an article (i.e., exclude user click data). In some cases, a topic may be described as a probability distribution of words. A topic model (e.g., LDA) may be used to discover underlying topics in a document or a collection of documents and infer word probabilities in topics. For example, a machine learning model is trained on multiple (more than 1000) articles (e.g., creative content) and the network model can identify topics (e.g., 8 topics) to group the set of articles. Each article is categorized according to the main topic. In some examples, the network model is an unsupervised learning model.

In some examples, the network model identifies a pre-determined set of topics (e.g., eight topics) and a clustering component of the network model is configured to cluster the content items using an unsupervised learning algorithm to obtain a set of content groups correspond to the set of topics. Key words include the phrase/word “draw” for topic 1 of the eight topics. The network model identifies frequency for each of the key words from a content item; identifies a subset of the set of topics based on the frequency for each of the key words; converting the set of topics to corresponding topic vectors; generates a vector representation of the content item based on the subset of the set of topics and the corresponding topic vectors; and identifies a set of nearest neighbors for the content item based on the vector representation, where the clustering is based on the nearest neighbors.

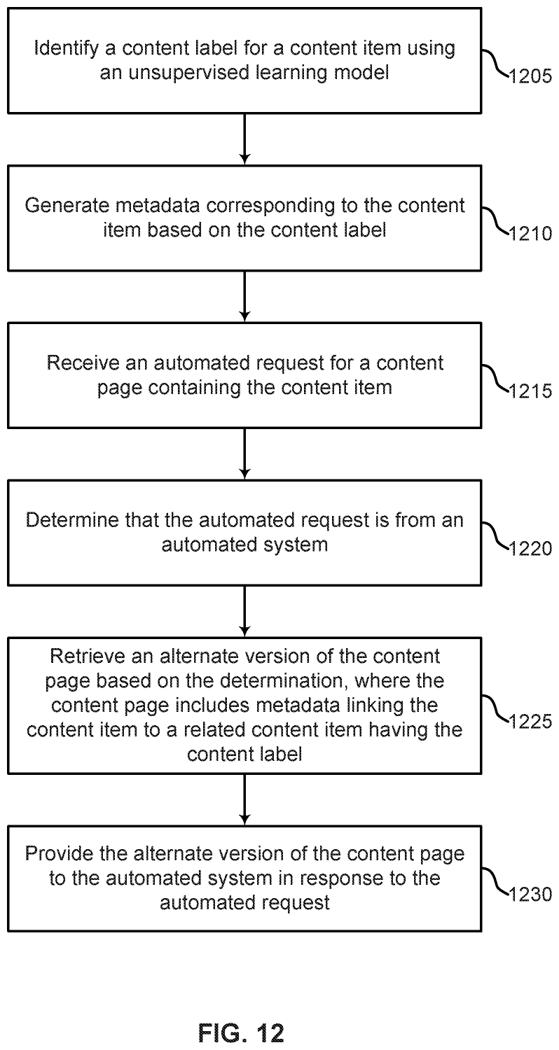

FIG. 12 shows an example of a process for content management based on an automated request according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

One or more embodiments of the present disclosure use unsupervised learning. Unsupervised learning is one of three basic machine learning paradigms, alongside supervised learning and reinforcement learning. Unsupervised learning draws inferences from datasets consisting of input data without labeled responses. Unsupervised learning may be used to find hidden patterns or grouping in data. For example, cluster analysis is a form of unsupervised learning. Clusters may be identified using measures of similarity such as Euclidean or probabilistic distance.

At operation 1205, the system identifies a content label for a content item using an unsupervised learning model. In some cases, the operations of this step refer to, or may be performed by, a clustering component as described with reference to FIG. 4. According to an embodiment, a clustering component of the content management system is configured to identify a content label for the content item using an unsupervised learning model.

At operation 1210, the system generates metadata corresponding to the content item based on the content label. In some cases, the operations of this step refer to, or may be performed by, a metadata component as described with reference to FIG. 4.

At operation 1215, the system receives an automated request for a content page containing the content item. In some cases, the operations of this step refer to, or may be performed by, a request manager as described with reference to FIGS. 4 and 5. The content management system performs main processing after registration. The main processing uses serverless compute units and includes metadata related and dynamic rendering pipeline. The content management system receives and validates metadata of incoming articles. In some examples, a JSON schema validation is performed to ensure the articles are correct. Next, the system transforms the article metadata according to the target website (i.e., an SPA such as CC Home) schema requirements. Additionally, the system determines that changes are needed for article database followed by update of the article database. In an embodiment, article database stores articles of a particular type from multiple web-based sources. The content management system keeps track of articles available in the database which provides an index for the search engine. A sitemap is generated for all languages which the search engine may select.

At operation 1220, the system determines that the automated request is from an automated system. In some cases, the operations of this step refer to, or may be performed by, a request manager as described with reference to FIGS. 4 and 5. In some examples, the automated system includes a bot.

At operation 1225, the system retrieves an alternate version of the content page based on the determination, where the content page includes metadata linking the content item to a related content item having the content label. In some cases, the operations of this step refer to, or may be performed by, a content retrieval component as described with reference to FIGS. 4 and 5. According to an embodiment, the content retrieval component is configured to retrieve a user version of the content page if the request is from a non-automated user (e.g., human user) and to retrieve an alternate version of the content page if the request is from the automated system (e.g., bot).

At operation 1230, the system provides the alternate version of the content page to the automated system in response to the automated request. In some cases, the operations of this step refer to, or may be performed by, a page service component as described with reference to FIGS. 4 and 5. According to an embodiment, the metadata related step is followed by a dynamic rendering process where a multiple processor page renderer is used to create search engine content based on input metadata. Dynamic rendering turns SPA into crawlable websites to be easily detected by bots. For example, in the content that has been rendered, each of the pages belong to the article database. However, if the content belongs to an external source, page rendering ensures that the content is crawlable by search engines.

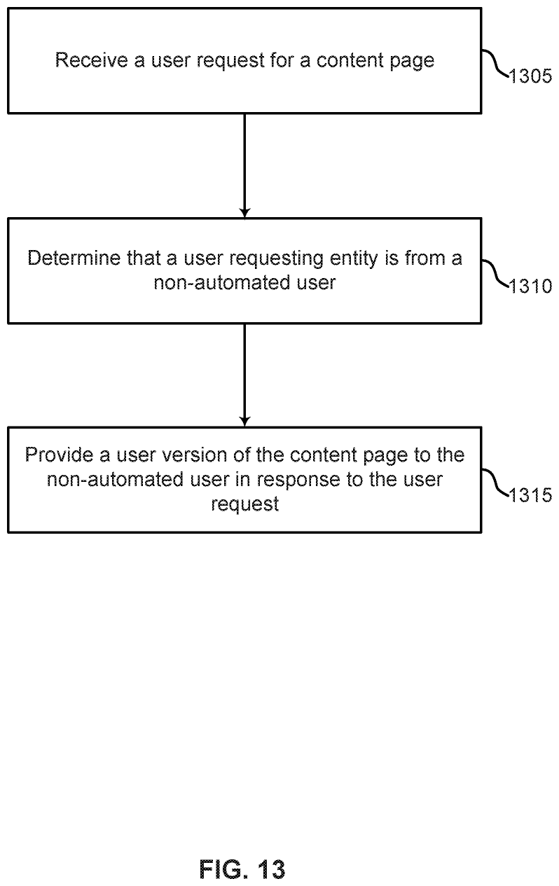

FIG. 13 shows an example of a process for providing a user version of a content page to a non-automated user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system receives a user request for a content page. In some cases, the operations of this step refer to, or may be performed by, a request manager as described with reference to FIGS. 4 and 5.

At operation 1310, the system determines that a user requesting entity is from a non-automated user. In some cases, the operations of this step refer to, or may be performed by, a request manager as described with reference to FIGS. 4 and 5.

At operation 1315, the system provides a user version of the content page to the non-automated user in response to the user request. In some cases, the operations of this step refer to, or may be performed by, a page service component as described with reference to FIGS. 4 and 5.

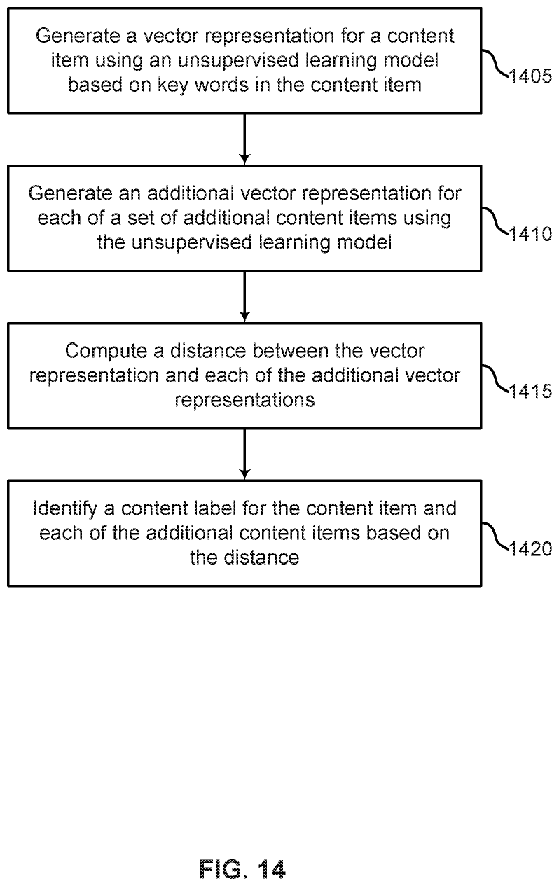

FIG. 14 shows an example of a process for content label identification according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment, an unsupervised model identifies frequency for each of the key words from a content item; identifies a subset of the set of topics based on the frequency for each of the key words; converts the set of topics to corresponding topic vectors; generates a vector representation of the content item based on the subset of the set of topics and the corresponding topic vectors; and identifies a set of nearest neighbors for the content item based on the vector representation, where the clustering is based on the nearest neighbors.

At operation 1405, the system generates a vector representation for a content item using an unsupervised learning model based on key words in the content item. In some cases, the operations of this step refer to, or may be performed by, a clustering component as described with reference to FIG. 4. According to an embodiment, the system identifies frequency for each of key words from a content item. The system identifies a subset of a set of topics based on the frequency for each of the key words.

According to some embodiments of the present disclosure, the content management system includes an unsupervised model for topic modeling using latent Dirichlet allocation (LDA). In some cases, the network model captures and processes text of one or more articles. Processing article text includes evaluating the frequency of each word. For example, a text may include words such as “festival”, “impossible”, “create” with frequencies of 10, 5 and 3 respectively. Next, the network model may choose the number of topics to describe articles (e.g., 8 topics).

At operation 1410, the system generates an additional vector representation for each of a set of additional content items using the unsupervised learning model. In some cases, the operations of this step refer to, or may be performed by, a clustering component as described with reference to FIG. 4.

At operation 1415, the system computes a distance between the vector representation and each of the additional vector representations. In some cases, the operations of this step refer to, or may be performed by, a clustering component as described with reference to FIG. 4. According to an embodiment, the system converts the set of topics to corresponding topic vectors. In some examples, the LDA model describes articles as vectors of the topics. The topic vectors are used to find the nearest neighbors with maximum overlap. The associated articles are then recommended to the users. The system generates a vector representation of the content item based on the subset of the set of topics and the corresponding topic vectors. The system identifies a set of nearest neighbors for the content item based on the vector representation, where clustering is based on the nearest neighbors.

At operation 1420, the system identifies a content label for the content item and each of the additional content items based on the distance. In some cases, the operations of this step refer to, or may be performed by, a clustering component as described with reference to FIG. 4.

Performance of apparatus, systems and methods of the present disclosure have been evaluated, and results indicate embodiments of the present disclosure have obtained increased performance over existing technology. Example experiments demonstrate that the content management system outperforms conventional systems and increases user engagement with creative content.

The content management system automatically integrates dynamic content coming from multiple sources while maintaining a SPA friendly content search engine. As a result, SEO equity can be integrated and/or relocated more easily. In some cases, machine learning post-processing generates user friendly additional content and helps a search engine crawl within the target website. The content management system automatically integrates data from multiple content systems into a single system while preserving SEO equity and smooth integration.

For example, an application that develops a magazine (e.g., Adobe® CREATE magazine) may be moved to a single page application (e.g., Adobe® CC Home) using the dynamic pipeline described above. In some cases, the existing equity of the magazine before the move may show a weekly cycle which represents user access or hit rate from search engines during the weekdays and weekends. For example, clicks by users between Monday and Friday will be more than clicks on Saturday and Sunday.

According to an embodiment, the content management system is configured to perform a post-processing step which further adopts machine learning to generate wall of links for search engines to crawl through the whole website. The machine learning generated list is user friendly and crawler friendly. For example, the articles are validated, and a pre-rendering is performed for the pages that users can reach. Additionally, an SEO bot which uses one of the pages can internally access the entire site.

One or more embodiments of the present disclosure include a content management apparatus that automatically moves content and enables the increase in equity after the move to a target application. As a result, user access of the original application decreases, for example, the hit rate of a magazine may decrease to approximately zero after moving the content of the application to a single page application. In some cases, the content is automatically moved or deported to another source using the SEO pipeline and user engagement is increased.

The description and drawings described herein represent example configurations and do not represent all the implementations within the scope of the claims. For example, the operations and steps may be rearranged, combined, or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for content management, comprising:
receiving a user request for a content page, wherein the content page includes a content item from a content source;
determining that the user request is from a non-automated user;
providing a user version of the content page to the non-automated user based on the determination that the user request is from the non-automated user, wherein the user version of the content page includes metadata linking to a related content item from a source other than the content source;
receiving an automated request for the content page;
determining that the automated request is from an automated system; and
providing an alternate version of the content page to the automated system based on the determination that the user request is from the automated system, wherein the alternate version of the content page includes additional metadata linking to a plurality of additional content items.

2. The method of claim 1, further comprising:
reading an identification field in the automated request that identifies a requesting entity as the automated system, wherein determining that the user request is from the non-automated user is based on the identification field.

3. The method of claim 1, further comprising:
identifying one or more content labels for the content item using an unsupervised learning model; and
generating the metadata corresponding to the content item based on the one or more content labels.

4. The method of claim 1, wherein:
the additional metadata is not contained in the user version of the content page.

5. The method of claim 1, wherein:
the automated system comprises a web crawler for a search engine.

6. The method of claim 1, further comprising:
generating a webhook for the content source; and
receiving the content item from the content source based on the webhook.

7. The method of claim 6, further comprising:
receiving an update to the content item based on the webhook; and
updating code for the user version of the content page based on the update.

8. The method of claim 1, further comprising:
storing the content item and the related content item in a common database.

9. The method of claim 1, further comprising:
identifying source metadata for the content item; and
converting the source metadata based on a metadata schema for a website to obtain the metadata.

10. The method of claim 1, wherein:
the additional metadata comprises a web link to each of the plurality of additional content items.

11. The method of claim 1, wherein:
the metadata comprises a keyword identifying a content label associated with the content item and the related content item.

12. A method for content management, comprising:
identifying a content label for a content item using an unsupervised learning model;
generating metadata corresponding to the content item based on the content label;
receiving an automated request for a content page containing the content item;
determining that the automated request is from an automated system;
retrieving an alternate version of the content page based on the determination, wherein the content page comprises metadata linking the content item to a related content item having the content label; and
providing the alternate version of the content page to the automated system in response to the automated request.

13. The method of claim 12, further comprising:
receiving a user request for the content page;
determining that a user requesting entity is from a non-automated user; and
providing a user version of the content page to the non-automated user in response to the user request.

14. The method of claim 12, further comprising:
generating a vector representation for the content item using the unsupervised learning model based on key words in the content item;
generating an additional vector representation for each of a plurality of additional content items using the unsupervised learning model;
computing a distance between the vector representation and each of the additional vector representations; and
identifying the content label for the content item and each of the additional content items based on the distance.

15. The method of claim 12, wherein:
the unsupervised learning model comprises a latent Dirichlet allocation (LDA) clustering algorithm, a latent semantic analysis (LSA) algorithm, a probabilistic latent semantic analysis (PLSA) algorithm, or an Lda2vec algorithm.

16. The method of claim 12, further comprising:
identifying a pre-determined set of topics, wherein the unsupervised learning model clusters content based on the pre-determined set of topics.

17. An apparatus for content management, comprising:
a request manager configured to receive a request for a content page, and to determine whether the request is from an automated system;
a content retrieval component configured to retrieve a user version of the content page if the request is from a non-automated user and to retrieve an alternate version of the content page if the request is from the automated system, wherein the user version and the alternative version include metadata linking to additional content items that have a same content label as a content item in the content page; and
a page service component configured to provide the user version or the alternate version of the content page in response to the request.

18. The apparatus of claim 17, further comprising:
a clustering component configured to identify a content label for the content item using an unsupervised learning model.

19. The apparatus of claim 17, further comprising:
a metadata component configured to generate the metadata based on a metadata schema for the content page.

20. The apparatus of claim 17, further comprising:
a website component configured to generate code for the user version of the content page and to generate code for the alternate version of the content page.
